(19) United States
(12) Patent Application Publication
(10) Pub. No.: US 2016/0300655 A1
(43) Pub. Date: Oct. 13, 2016

(54) Site Replacement Of Internal Saturable Reactors Of A Rectifier Power Transformer

(71) Applicant: ABB INC., Saint-Laurent (CA)

(72) Inventor: Ed G. teNyenhuis, Guelph (CA)

(73) Assignee: ABB Inc., Saint-Laurent (CA)

(21) Appl. No.: 15/037,776

(22) PCT Filed: Jan. 12, 2015
(86) PCT No.: PCT/CA2015/000016

§ 371 Date: May 19, 2016

(30) Foreign Application Priority Data
Jan. 21, 2014 (CA) 2,840,383

(51) Int. Cl. H01F 27/00; H01F 27/12

(52) U.S. Cl. CPC H01F 27/004; H01F 27/12

(57) ABSTRACT

A method replaces a saturable core reactor (SCRs) in a rectifier power transformer disposed in a transformer vault at its field location. The transformer has an oil-filled tank housing the SCRs. The tank has a manhole opening therein. A busbar structure is associated with each SCR. The method drains the oil from the tank. A busbar structure is disconnected from an associated SCR. The disconnected busbar structure is moved away from the transformer. The SCR is removed from the tank through the manhole opening and is lowered. The SCR is then conveyed from the transformer vault. A replacement SCR is moved to be adjacent the manhole opening and is then slid through the manhole opening and into the tank to a certain location. The busbar structure is moved so as to be associated with a replacement SCR and is connected to the replacement SCR.

### FIELD

The invention relates to large rectifier power transformers and, more particularly, to field replacement of saturable core reactors in an existing and installed rectifier power transformers.

### BACKGROUND

Saturable core reactors (SCR) are used in rectifier power transformers to perform fine control of the secondary busbar voltage to the rectifiers and DC bus. SCR's are large wound electrical steel cores with small control and bias windings wound over top. The secondary busbars go through the SCR wound cores. It is common to have twelve SCR's and the weight of each SCR can be more than one ton. The SCRs fit in a tight arrangement inside the transformer tank and are immersed in oil.

Normally, the replacement of the SCR's is done in a transformer factory or repair shop due to the large size and mass of each SCR. Below is the conventional procedure that is performed in a transformer repair factory:
Disconnect the transformer, remove from the transformer bay and place on railcar for transport to the factory
At the factory, remove the transformer cover, perform disconnections on the low voltage side (can be 100's), lift the main core and coils from the tank and remove the old SCR's from the tank with an overhead crane
Perform vapor phase dryout of the core and coils and new SCR's
Install the new SCR's with an overhead crane
Re-install the core and coils and reconnect the low voltage side
Vacuum fill with oil and perform testing
Prepare transformer for rail shipment back to the site
Re-install the transformer.

This process is very costly due to the cost of removal of the SCRs, complicated disconnection of the low voltage side, transportation of the SCR to and from the factory, and reinstallation.

Thus, there is a need to provide a method of field replacement of SCRs in an existing and installed rectifier power transformer.

### SUMMARY

An object of the invention is to fulfill the need referred to above. In accordance with an embodiment, this objective is achieved by a method of replacing a plurality of saturable core reactors (SCRs) in a rectifier power transformer disposed in a transformer vault at its operating, field location. The transformer has an oil-filled transformer tank that houses the SCRs. The tank has at least one manhole opening therein. A busbar structure is associated with each SCR. The method includes:
a) draining the oil from the tank,
b) disconnecting a busbar structure from an associated SCR,
c) moving the disconnected busbar structure away from the transformer,
d) repeating steps b) to c) for each busbar structure,
e) accessing the at least one manhole opening,
f) removing a SCR from the tank through the at least one manhole opening,
g) lowering the removed SCR,
h) conveying the removed SCR from the transformer vault,
i) repeating steps f) to h) for the other SCRs disposed in the tank,
j) moving a replacement SCR to be adjacent to at least one manhole opening,
k) sliding the replacement SCR through the at least one manhole opening and into the tank to a certain location,
l) repeating steps j) to k) to place the other replacement SCRs in the tank,
m) moving a busbar structure so as to be associated with a replacement SCR and connecting the busbar structure to the replacement SCR, and
n) repeating step m) for each of the other replacement SCRs in the tank.

In accordance with another aspect of an embodiment, a system is provided for removal and replacement of a plurality of saturable core reactors (SCRs) in a rectifier power transformer disposed in a transformer vault at its operating, field location. The transformer has a busbar structure associated with each SCR. The system includes a lifting structure constructed and arranged to be coupled with a busbar structure. A first gantry crane has a first hoist constructed and arranged to engage and move the lifting structure and thus move the busbar structure when coupled to the lifting structure. A second gantry crane has a second hoist constructed and arranged to engage and move a SCRs. A conveyor is constructed and arranged to permit a SCR to be removed from the transformer vault.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings wherein like numbers indicate like parts, in which:

FIG. 1 is a perspective view of a rectifier power transformer and a system for removal and replacement of a plurality of saturable core reactors (SCRs) of the transformer in accordance with an embodiment.

FIG. 2 is a perspective view showing a lifting structure, in accordance with an embodiment, for lifting busbar structure.

### DETAILED DESCRIPTION OF AN EXEMPLARY EMBODIMENT

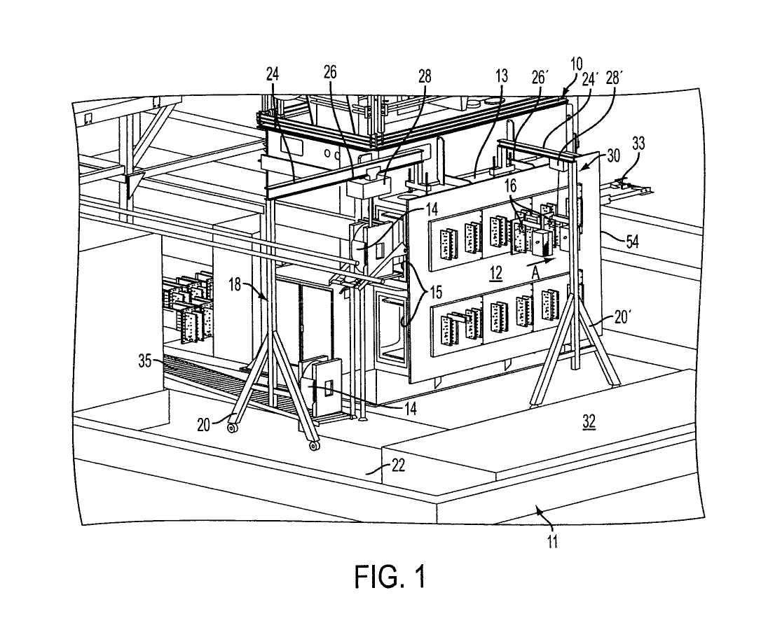

FIG. 1 is a perspective view of a rectifier power transformer, generally indicated at 10, installed in a transformer vault, generally indicated at 11, at its operating, field location. The transformer 10 includes a transformer tank 12 that houses a plurality of conventional, saturable core reactors (SCR) 14. The tank 12 has a top cover 13, and manhole openings 15 at a side of the tank 12 for gaining access to the SCRs 14 without removing the top cover 13. The manhole openings 15 are shown in an open condition, with manhole covers removed. In the embodiment, twelve SCRs 14 are arranged in two vertically stacked rows of six SCRs per row. FIG. 1 shows two of the SCRs 14 removed from the tank 12, as will be explained below. A conventional, low voltage (LV) busbar structure 16 is electrically connected with each SCR 14 and passes through the wound cores thereof.

A method and special system is disclosed to perform replacement of the SCRs 14 at the field location to save considerable cost, time and transformer outage time. The cost of removing the transformer 10 from service, heavy truck or rail transport to/from the factory and re-installation of the transformer 10 are the main cost and time savings of field replacement.

With reference to FIG. 1 and in accordance with an embodiment, a gantry crane, generally indicated at 18, is provided for removing the SCRs from the tank 12. The gantry crane 18 includes a base 20 engaged with the floor 22 at the field location and a beam 24 extending from the base 20. The beam 24 can be temporarily fixed to the tank 12. The beam 24 includes rails 26 on each side thereof for carrying and guiding a chain or cable host 28 along a length of the beam 24. The gantry crane 18 preferably has a 12 feet beam 24 and a one ton hoist 28. Another gantry crane, generally indicated at 30, is provided for moving the LV busbar structure 16, as will be explained below. Gantry crane 30 is similar to crane 18, but need not be as robust as crane 18. Thus, gantry crane 30 includes a base 20′ engaged with the floor 32 at the field location and a beam 24′ extending from the base 20′. The beam 24′ can be temporarily fixed to the tank 12. The beam 24′ includes rails 26′ on each side thereof for carrying and guiding a chain or cable hoist 28′ along a length of the beam 24′. The other gantry crane 30 preferably has a six foot beam 24′ and a half ton hoist. A winch system 33 is provided for pulling the SCR 14 on SCR support plates (not shown and inside the transformer tank 12) when installing the replacement SCR 14. A conveyor 35 is provided for removing the SCR from the transformer vault 11. Preferably, the conveyor 35 is built to exactly match the vault layout and door exit from the vault. The conveyor 35 is of light weight so as to be capable of being manipulated by hand by a user and to be able to be disposed on the typical metal grate floor of the vault.

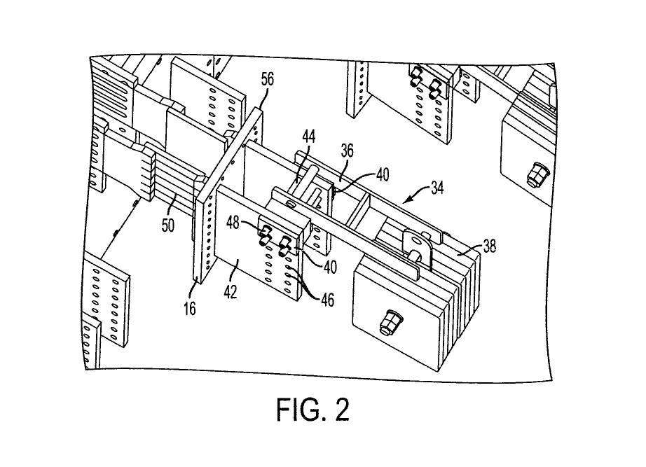

In order to remove each SCR 14 from the tank 12, the associated busbar structure 16 must be disconnected from each SCR 14 and lifted as will be explained below. Thus, with reference to FIG. 2, lifting structure, generally indicated at 34, is provided and includes a lift arm 36 and a counter-weight 38 coupled thereto to counter the weight of a busbar structure 16 when coupled to the lift arm 36, as explained below.

Workers at the filed location perform the task of disconnecting each old SCR 14 one at a time and then safely remove the SCRs from the transformer tank 12 with the gantry crane 18. In particular, the preferred steps of removal of the old SCRs 14 include:
1. Perform as found electrical tests of the transformer 10.
2. Drain the oil from the transformer tank 12.
3. Obtain access to the manhole openings 15 by removing cover (not shown). Check the gas inside the transformer tank 12 and prepare for the confined space entry.
4. Prepare the site by installing the gantry cranes 18 and 30 as shown in FIG. 1.
5. Start by removing the bolts of the busbar structure 16 connections: two bolted connections per SCR 14 at the top and two bolted connections per SCR at the bottom. These are the busbar structures 16 going through the SCR 14. Ensure all hardware is accounted for. Note that this hardware should be replaced.
6. From the LV side of the transformer 10, remove the LV busbar structure 16 corresponding to the unbolted internal connection. Prepare the lifting structure 34. Install an insulation pad 40 between the lifting structure 34 and the terminal 42 (see FIG. 2). Install an insulation tube 44 through terminal holes 46 and holes (not seen) in the lift arm 36 of the lifting structure 34 before inserting the threaded studs 48 in the terminal 42.
7. Couple the lifting structure 34 to the hoist 28′ of the gantry crane 30 to move each busbar structure 16. The counterweight 38 of the lifting structure 34 balances the weight of the busbar structure 16 so that lifting and moving by the crane 30 is made easier. Extreme caution should be given to the handling and temporary storage of the busbar structure 16 to protect the silver plating. Store the busbar structure 16 in prepared crates with plastic covering.
8. Prepare a clamp that will fit around the flex cables 50 (FIG. 2). It is important to note that the clamp has to maintain 120 mm distance between the side of the flexes that connect to the SCR bus and 150 mm between the side of the flexes that connect to the busbars going through the outer plate. It should be noted that these distances are center line to center line and for the SCR it should be verified.
9. Repeat steps above until all the busbar structures 16 have been removed and stored in a safe, clean place, remote from the transformer 10.
10. Disconnect the first group of the Amplistat control windings from the main connection at one end and the next SCR 14 on the other end.
11. Slide the SCR 14 as close as possible to the manhole opening 15 (FIG. 1) and attach the SCR 14 to the hoist 28 of the gantry crane 18 to remove the SCR from the tank 12 though the manhole opening 15.
12. Use the crane 18 to lower the SCR 14 onto a conveyor 35 and then move the SCR 14 along the conveyor from the transformer vault 11 to the outside.
13. Repeat steps above for the remaining SCRs 14.
14. Proceed to dismantle the SCR support. Remove the fiber glass shelves. These should be cleaned and stored. Discard the pressboard support.
15. Proceed to rebuild the SCR support with the new supplied structure.
16. Attach the cleats for the Amplistat control wiring.
17. Run the top wires according to the wiring diagram and leave enough cable length to connect to the SCR's control winding.
18. Note that each SCR weighs around 900 kg (700 kg of steel and the rest is mainly the weight of the insulation and support) and a means of disposing of them should be pre-arranged.

A preferred procedure for the installation of new or replacement Saturable Core Reactors (SCR) 14 includes:
1. Use the gantry crane 18 to lift the new SCR 14 to be adjacent to a manhole opening 15. Caution should be used when installing and using the gantry crane 18 so as not to damage the windings and when moving the SCRs so as not to bump them.
2. Place a sling around the new SCR 14. Slide the first SCR 14 into the tank 12 through the manhole 15 (in the direction of arrow A) and position it at the opposite end 54 of the tank 12. The winch system 33 is used to pull the SCR's on the SCR shelf in the tank 12 to a certain location in the tank. Connect the control wires.
3. Repeat steps 1 and 2 for the next SCR 14. Connect the corresponding control wires to each other.
4. Continue the process until all six SCRs 14 are installed in the bottom row and the control wiring is connected to the start and finish wires connected to the bushings.
5. Repeat step 1 to 4 to install the SCRs on the top row.

A preferred procedure for the installation of the busbar structure 16 through the Saturable Core Reactors (SCR) 14:
1. Remove the insulating board at the LV side. Replace the gasket and mount the board again.
2. Use the gantry crane 30 and lifting structure 34 to manipulate the busbar structure 16.
3. Start on one end for the bottom row of SCRs.
4. Insert the LV busbar structure 16 (FIG. 2) with the Flex Clamp already installed through the insulating board and the SCR 14. Note this clamp will replace the previous clamp and stay in the transformer tank 12.
5. From the side manhole opening 15, make sure the insulation between the core and the busbar structure 16 remains in place. Also make sure the insulation between the two arms of the busbar structure is in place and the oil ducts are not obstructed.
6. Keep the busbar structure 16 leveled as much as possible while reconnecting the back end to the flex cables 50. Make sure all the bolts are well tightened. Use new hardware.
7. Secure the connecting plate 56 in place.
8. Repeat step 4 to 7 for the other busbar structures 16.
9. Once all the busbar structures 16 are in place, do a final inspection of all busbar connection bolts.
10. Connect SCR winding.
11. Perform transformer dryout.
12. Perform final transformer electrical testing.

The overall procedure also includes full transformer pre testing, post testing and complete transformer dryout using a special Low Frequency Heating technology. All work is done using present transformer tank openings.

The main features of the method of the embodiment are:
Being able to perform all work on site where the transformer 10 is presently installed
Perform the repair during an outage that does not cause loss of production/revenue for the transformer user
Safe removal of the SCR's from the tank 12 using powered equipment (i.e., not removed using the workers)
Utilization of the existing transformer tank openings 15 to remove/replace the SCRs without removing the cover 13
Being able to dryout the transformer when the replacement is done (transformers require very low levels of dryness for dielectric strength)
Reduce the cost of the SCR replacement, with the cost saving estimated to be 60% versus off-site factory replacement
Estimated 80% time savings versus off-site factory replacement
Safety of the worker is considered (no manual lifting required of the heavy SCR)

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

What is claimed is:

1. A method of replacing a plurality of saturable core reactors (SCRs) in a rectifier power transformer disposed in a transformer vault at its operating, field location, the transformer having an oil-filled transformer tank that houses the SCRs, the tank having at least one manhole opening therein, a busbar structure being associated with each SCR, the method comprising the steps of:
a) draining the oil from the tank,
b) disconnecting a busbar structure from an associated SCR,
c) moving the disconnected busbar structure away from the transformer,
d) repeating steps b) to c) for each busbar structure,
e) accessing the at least one manhole opening,
f) removing a SCR from the tank through the at least one manhole opening,
g) lowering the removed SCR,
h) conveying the removed SCR from the transformer vault,
i) repeating steps f) to h) for the other SCRs disposed in the tank,
j) moving a replacement SCR to be adjacent the at least one manhole opening,
k) sliding the replacement SCR through the at least one manhole opening and into the tank to a certain location,
l) repeating steps j) to k) to place the other replacement SCRs in the tank,
m) moving a busbar structure so as to be associated with a replacement SCR and connecting the busbar structure to the replacement SCR, and
n) repeating step m) for each of the other replacement SCRs in the tank.

2. The method of claim 1, wherein the steps of moving the busbar structure include coupling lifting structure to the busbar structure, and attaching the lifting structure to a hoist of a gantry crane.

3. The method of claim 2, wherein the lifting structure includes a lifting arm coupled to the busbar structure and a counter-weight coupled to the lifting arm.

4. The method of claim 1, wherein the removing and lowering steps include attaching the SCR to a hoist of a gantry crane and using the crane to remove and lower the SCR.

5. The method of claim 1, wherein the at least one manhole opening is in a side of the tank and the sliding step includes using a winch system to pull the replacement SCR into the tank.

6. The method of claim 4, wherein the step of moving the replacement SCR includes using the gantry crane.

7. The method of claim 1, wherein the conveying step includes using a conveyor disposed on a floor of the transformer vault.

8. The method of claim 1, further comprising the step of drying out the transformer after step n).

9. A system for removal and replacement of a plurality of saturable core reactors (SCRs) in a rectifier power transformer disposed in a transformer vault at its operating, field location, the transformer having a busbar structure associated with each SCR, the system comprising:
lifting structure constructed and arranged to be coupled with a busbar structure,
a first gantry crane having a first hoist constructed and arranged to engage and move the lifting structure and thus move the busbar structure when coupled to the lifting structure,
a second gantry crane having a second hoist constructed and arranged to engage and move a SCRs, and
a conveyor constructed and arranged to permit a SCR to be removed from the transformer vault.

10. The system of claim 9, further comprising a winch system constructed and arranged to pull a replacement SCR into the tank.

11. The system of claim 9, wherein each gantry crane comprises:
a base constructed and arranged to engaged a floor of the vault, and
a beam extending from the base, the beam including rails on each side thereof for carrying and guiding the hoist along a length of the beam.

12. The system of claim 9, wherein the first hoist is a half-ton hoist and the second hoist is a one-ton hoist.

13. The system of claim 9, wherein the lifting structure includes a lifting arm constructed and arranged to be coupled to a busbar structure and a counter-weight coupled to the lifting arm, the counter-weight being constructed and arranged to generally balance a weight of a busbar structure.

14. The system of claim 9, wherein the conveyor is constructed and arranged so as to be capable of being manipulated by hand by a user.

15. The system of claim 9, in combination with the transformer, the transformer having a tank, the tank having at least one manifold opening in a side thereof, the second gantry crane being constructed and arranged to move the SCRs with respect to the at least one manifold opening.
